(19) United States
(12) Patent Application Publication
(10) Pub. No.: US 2003/0048772 A1
(43) Pub. Date: Mar. 13, 2003

(54) System for converting GR303 signals to NCS signals

(75) Inventor: William H. Blum, Harleysville, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(73) Assignee: General Instrument Corporation, Horsham, PA

(21) Appl. No.: 09/941,335

(22) Filed: Aug. 29, 2001

(51) Int. Cl. H04L 12/64

(52) U.S. Cl. 370/352; 370/401; 370/467

(57) ABSTRACT

The invention provides a communication system architecture in which a hybrid fiber coax (HFC) network utilizing an Internet protocol (IP) through an IP network is connectable to a local digital switch (LDS) within a public switched telephone network (PSTN). An IP digital terminal (IPDT) is provided as the link between the LDS and the IP network. The IPDT serves to translate both signaling and voice data between the two networks.

### BACKGROUND

Along with the increased use of the Internet and demand for services such as pay-per view movies, on demand music, and other services requiring a bi-directional communication system, there comes an increased need for additional infrastructure extending to a customer's location in order to provide these services. There are several approaches to add the infrastructure necessary for establishing such a bi-directional communication system. One approach is to utilize additional local loop type telephone lines to each home. Another approach is to utilize the existing cable TV (CATV) networks which have excess bandwidth for providing the services. One way to provide voice service is to carry it using Internet Protocol (IP) over a hybrid fiber coax (HFC) infrastructure. This has the advantage of allowing a common infrastructure for both voice and data in the HFC plant.

When using IP to carry voice, some connections can stay on the IP network while others must connect to the public switched telephone network (PSTN) to allow calls to non-IP subscribers. CableLabs is a cable industry funded organization which is defining the PacketCable series of standards that define a full suite of voice over IP (VoIP) capabilities. In the full PacketCable architecture, there are no end-office class 5 switches. FIG. 1 provides an overview of this architecture whereby the end-office switch functionality is instead provided through a combination of systems including a Call Agent, Signaling Gateway, Trunking Gateway, and Residential Gateways. In the PacketCable approach, the Call Agent uses aprotocol called Network Call Signaling (NCS) to manage the setup and tear down of voice connections over the IP backbone.

However, a significant number of cable operators already own class 5 end office switches and already provide either residential or business telephone service. These switches typically support a BellCore/Telcordia standard interface to circuit concentration devices called remote digital terminals (RDT). This interface is called GR303.

Both the NCS and GR303 protocols contain signaling such as off hook, ring, connection, disconnection, etc. In addition to the signaling protocols, voice communication protocols are included. In the NCS protocol, both signaling and voice are transmitted within digital packets of data in well defined different streams. In the GR303 protocol, some signaling is done in a separate stream and other signals are “piggybacked” on the voice stream. As a result, the GR303 protocol is sensitive to timing relationships between the signaling and voice protocol components.

For example, in establishing a call, a ring sequence is sent utilizing the signaling protocol. The ring sequence may be the normal balanced on-off cycle, or cycles with different cadences called distinctive and/or custom ring. In GR303, ring control is done using a “piggy-backed” scheme called robbed bit signaling. Ring control is done by the switch, where the starting and stopping of each ring is discretely controlled by robbed bits in the voice stream. In between the first and second ring, a caller ID signal may be sent. The caller ID signal must arrive at the receiving customer location at a given time after the first ring signal and at a given interval before the second ring signal. If the caller ID information does not arrive during the given time period, it will not be displayed at the receiving customer's caller ID device. In GR303, the switch plays out the caller ID signal in between the first and second rings, and can easily control the timing relative to the robbed bits that control the ringing.

In a system as shown in FIG. 2, all of the signaling commands must be converted from GR303 on the PSTN side to an IP protocol such as NCS on the IP network side. The signaling commands must be converted and sent in each direction so as to preserve the timing and minimize overall delay. For example, the timing must be preserved between the first and second ring and the caller ID information in order for the receiving telephone to display the caller ID. Also, special ring cadences should be supported without incurring additional delay associated with “parsing” the pattern.

For the foregoing reasons, there is a need for a method and apparatus to link an IP network carrying voice telephony with a PSTN. Moreover, there is a need for a method and apparatus for translating signaling between a GR303 interface and a VoIP enabled access network interface without incurring additional delay.

### SUMMARY

The present invention is directed at a method and system for interfacing a PSTN to an access network such as a HFC network for delivery of IP-based telephony service. In particular, the present invention describes a method for interfacing a GR303-based interface to a VoIP enabled access network such as the HFC network to support telephony signaling between the two interfaces.

In one embodiment, a method for interfacing a PSTN with a VoIP enabled access network is described. The method comprises: (1) receiving incoming call signaling from a PSTN, wherein the incoming call signaling is in a digital trunk format; (2) converting the call signaling to a packet-based VoIP call signaling message stream; and (3) transmitting the packet-based VoIP call signaling stream to a VoIP receiving device.

The method may further comprise receiving the packet-based VoIP call signaling at a VoIP receiving device; and generating signaling compatible with a residential PSTN phone device.

These and other features and objects of the invention will be more fully understood from the following detailed description of the preferred embodiments which should be read in light of the accompanying drawings.

### BRIEF DESCRIPTION OF THE DRAWING(S)

The accompanying drawings, which are incorporated in and form a part of the specification, illustrate the embodiments of the present invention and, together with the description serve to explain the principles of the invention. In the drawings:

FIG. 1 illustrates a full Voice over Internet Protocol (VoIP) architecture as specified in the PacketCable standards;

FIG. 2 illustrates an architecture which can support the principles of the method and apparatus of the present invention;

FIG. 3 illustrates a block diagram of the Internet Protocol Digital Terminal (IPDT);

FIG. 4 illustrates a call flow illustrating the method of the present invention;

FIG. 5A illustrates a flowchart for processing an off-hook event using Real-Time Protocol (RTP); and

FIG. 5B illustrates a flowchart for translating RTP telephony events signaling into (ABCD) signaling.

### DETAILED DESCRIPTION OF THE PREFERRED EMBODIMENT(S)

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

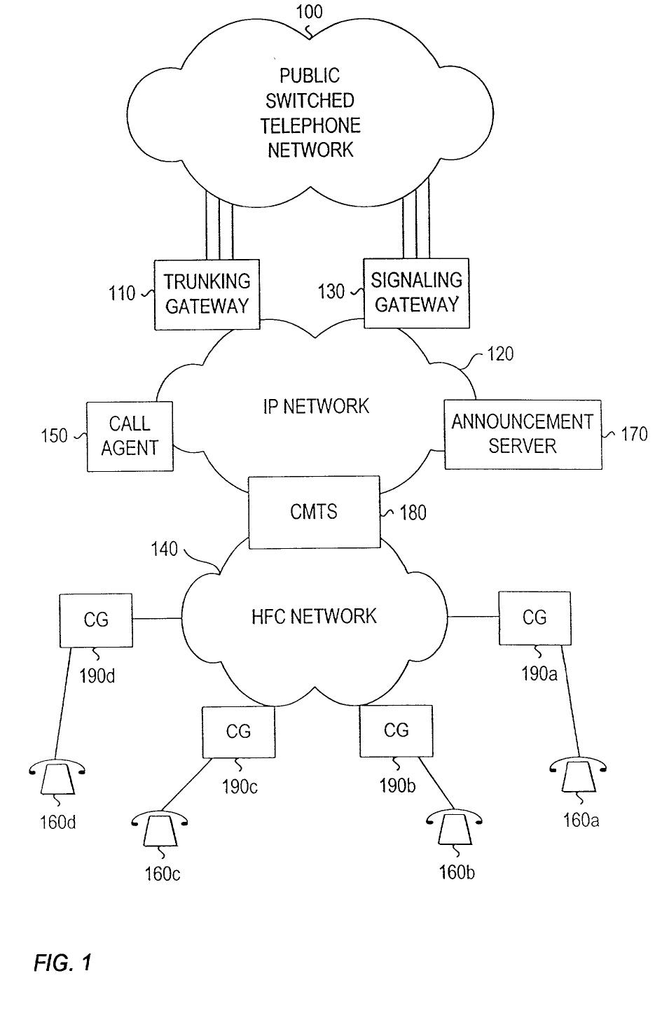

With reference to the drawings, in general, and FIGS. 1 through 5B in particular, the method and apparatus of the present invention is disclosed.

FIG. 1 shows a full Voice over Internet Protocol (VoIP) architecture as specified in the PacketCable standards. In FIG. 1, a plurality of residential communications gateways (CGs) 190a-190d are connected to subscriber telephone handsets 160a-60d. Each CG 190 is connected to a hybrid fiber coax (HFC) network 140. The CGs 190a-190d act as cable modems with telephony capability. In one embodiment, each CG 190 contains a Data Over Cable Service Interface Specifications (DOCSIS)-based modem for supporting voice, data and possibly video. Each CG 190 supports one or more distinct phone lines and a local Ethernet port for high speed data access. A cable modem termination system (CMTS) 180 connects the HFC network 140 to an IP-based network 120. The CMTS 180 acts as an edge router or bridge, converting the cable modem technology of the HFC network 140 to a standard link layer protocol such as Ethernet on the IP network 120. A trunking gateway 110 provides voice connectivity between the IP network 120 and a PSTN 100. The trunking gateway 110 performs media transcoding such as codecs and echo cancellation between both networks. As an example, the trunking gateway 110 may transcode an 6.729 encoded voice stream originating form the IP network 120 to an ITU 6.711 encoded voice stream destined to the PSTN 100. The references to 6.711 and 6.729 are standard voice compression algorithms specified by the International Telecommunication Union (ITU) which are known to those skilled in the art. A Signaling Gateway 130 performs signaling interconnection between the IP network 120 and a SS#7 signaling network of the PSTN 100. The Trunking Gateway 110 and the Signaling Gateway 130 are controlled by a Call Agent 150 which is also connected to the IP network 120. An Announcement Server 170 is utilized to deliver prerecorded messages to customers.

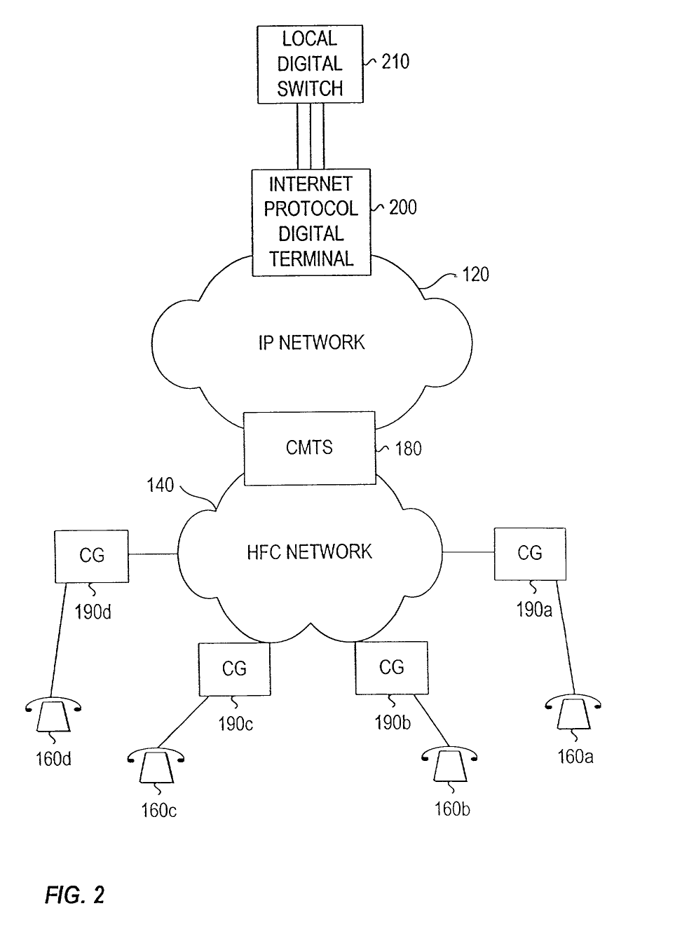

FIG. 2 shows an architecture which can support the method and apparatus disclosed in the present invention. The HFC network 140 portion of this architecture is the same as the full VoIP approach described in FIG. 1. However, the Call Agent 150 and its related components are replaced with an Internet Protocol Digital Terminal (IPDT) 200. The IPDT 200 connects the IP network 120 to a Local Digital Switch (LDS) 210 of the PSTN (not shown here). In one embodiment, the interface between the IPDT 200 and the LDS 210 is based on GR303 interface. In another embodiment, the interface may be based on European Telecommunications Standards Institute (ETSI) V5 interface specifications. The IPDT 200 is capable of translating both call signaling packets and voice packets on the IP network 120 to their appropriate counterparts on the LDS 210.

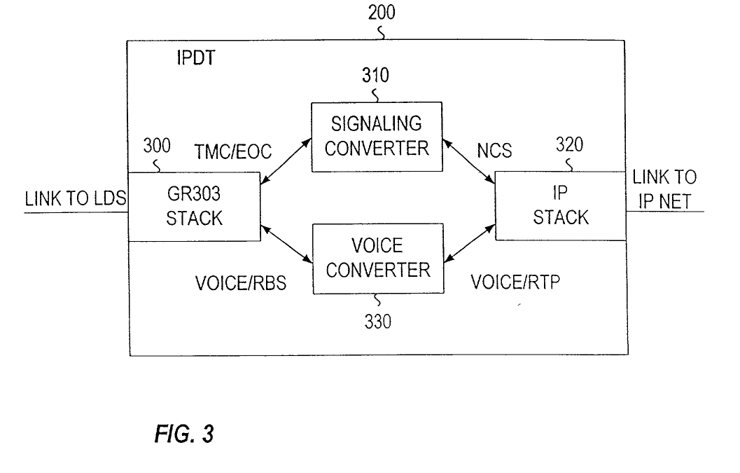

The IPDT 200 will be now described in greater detail with reference to FIG. 3. The present description is based on the use of a GR303-based interface, however the method of the present invention may be applied to an ETSI V5-based interface. The IPDT 200 is connected to the IP network 120 via an IP stack 320. Two paths extend through the IPDT 200 from the IP stack 320. A first path extends from the IP stack 320 through a signaling converter 310 to a GR303 stack 300 and then to a signaling port of the LDS 210 (shown in FIG. 2). A second path extends from the IP stack 320 through a voice converter 330 to the GR303 stack 300 to a voice port of the LDS 210.

On the IP side, voice is carried within Real Time Protocol (RTP) packets, and signaling is carried within Network Control Signaling (NCS) packets. The packets are constructed of a nested series of headers and then the payload. The first header is the link layer, then there is an Internet Protocol (IP) header, a User Datagram Protocol (UDP) header, and then finally the NCS or RTP payload. In the UDP header, there is a logical port number. In IP based client/server applications, this port number is intended to identify the target application in the IP endpoint. In the system of the present invention, the UDP port number is the mechanism for marking signaling vs. voice packets, and the NCS signaling application will have a fixed port number, known by both endpoints.

In the IPDT 200, the signaling converter 310 application sends and receives packets with the NCS port number. The endpoints are responsible for dynamically allocating the port numbers to be used for RTP packets. The allocated RTP port numbers are communicated between the endpoints using the NCS protocol. In the IPDT 200, the voice converter 330 application sends and receives packets with the RTP port number.

On the LDS side, voice and signaling are carried using Time Division Multiplexed (TDM) techniques. In the US, the common TDM circuit is T1. Its international counterpart is the E1. A T1 is a serial 1.544 Mbps stream which is broken into twenty-four channels, each called a DS0. Each DS0 has a speed of 64 Kbps. In GR303, a set of T1s and their DS0 channels are organized into what is called an Interface Group. In the system of the present invention, the channel number is the mechanism for marking signaling versus voice streams. Most of the DS0 channels of the Interface Group are pooled together, to be used for voice streams. In the IPDT 200, the voice converter 330 application converts RTP packets on a particular logical port to bits in the DS0 channel. Four DS0s of an Interface Group are reserved for control. These channel numbers are fixed and known by both endpoints. Two DS0s are used as the primary and redundant Embedded Operations Channel (EOC). The EOC is used for network monitoring and control functions. A second DS0 pair is used as the primary and redundant Timeslot Management Channel (TMC). The TMC is used to signal the dynamic allocation and deallocation of voice DS0s from the pool of DS0s in the Interface Group. In the IPDT 200, the signaling converter 310 application converts NCS packets on the signaling UDP port to TMC commands and/or responses on the TMC DS0 channel. Additionally, each voice DS0 may additionally carry some signaling information. The technique here is called robbed bit signaling (RBS) because some of the sampled voice bits are, in fact, overlaid with control information. In the IPDT 200, the voice converter 330 application must move robbed bit control information from/to the DS0 stream to/from RTP packets.

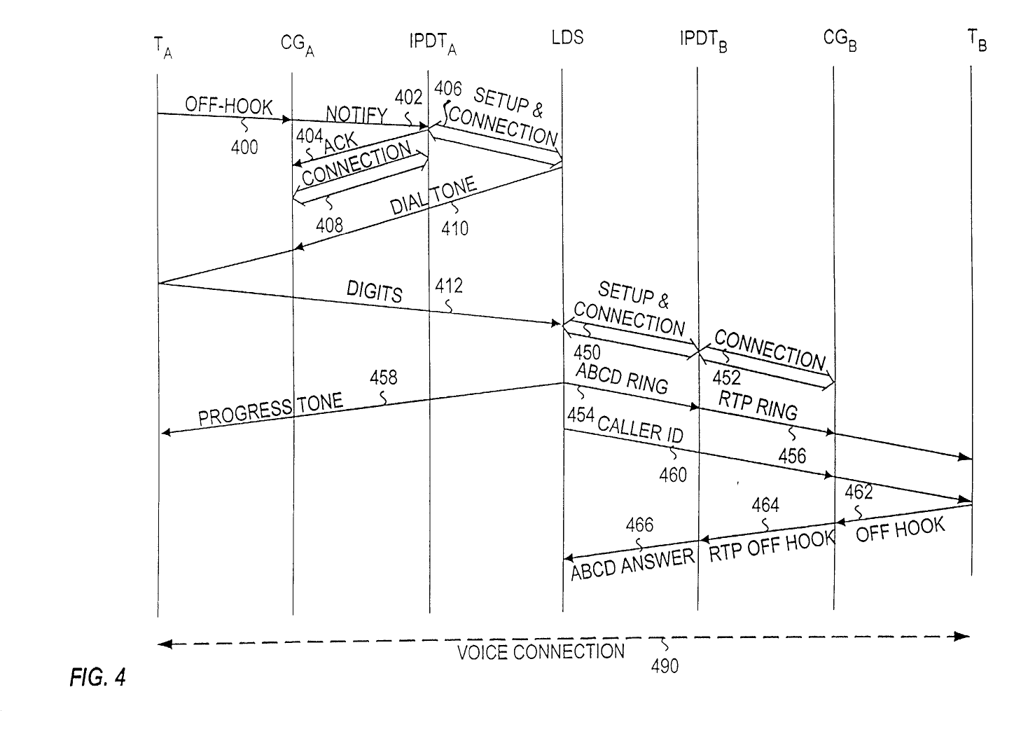

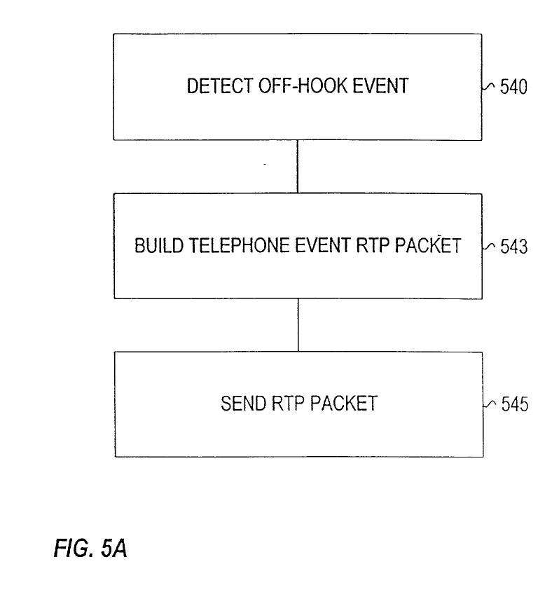

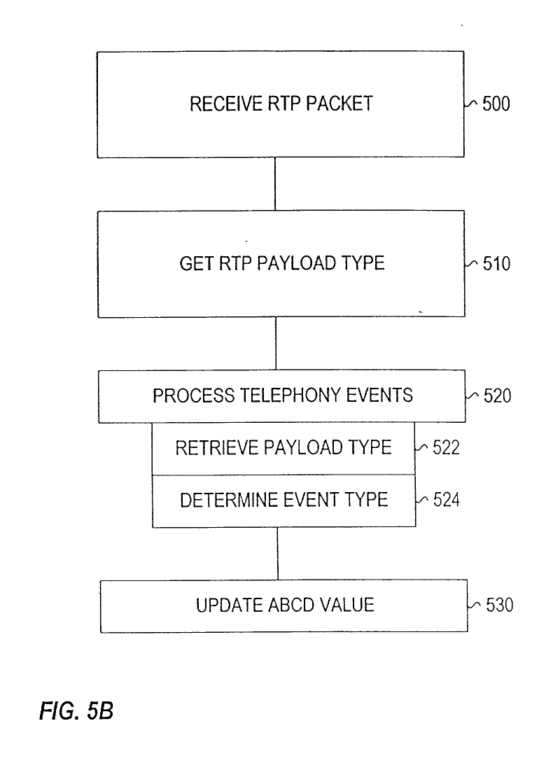

In operation, both signaling and voice packets are converted within the IPDT 200. An example of the conversion process is shown in the call flow diagram of FIG. 4 which is based upon the NCS call setup protocol. This protocol described in the “PacketCable Network-Based Call Signaling Protocol Specification” is herein incorporated by reference. As illustrated in FIG. 4, a subscriber at a location A picks up a telephone (T_{A}) handset 160a and an off hook signal 400 is detected by an originating CG (CG_{A}). The CGA sends to an associated IPDT (IPDT_{A}) an off-hook notification 402 based on the NCS signaling protocol. In another embodiment, an RTP-based signaling is used to signal the off-hook event, (described in accordance with FIG. 5A).

The IPDT_{A} acknowledges the off-hook notification 404 and exchanges with a local digital switch 210 (LDS) setup and connection messages 406 which results in the LDS 210 assigning a DS0 time slot on a GR303 link. The IPD_{TA} creates a connection 408 with the CG_{A}, and the CG_{A} processes the connection and requests allocation of Quality Of Service (QoS) resources from the HFC network 140. At this point of the call flow, we have a logical pipe flowing between the CG_{A} and the LDS 210.

The LDS plays dial tone back 410 to the end user which responds by entering digits 412 identifying the called party at a distant location B and which are passed along the pipe to the LDS 210 from the received digits 412. The LDS 210 identifies a destination IPDT (IPDT_{B}) that services the called party, and the LDS 210 establishes a call set up and a connection 450 with the IPDT_{B}. The IPDT_{B} creates a connection 452 with a destination CG (CG_{B}). The CG_{B} then processes the connection request and requests QoS from the HFC network 140. The LDS 210 sends a ring signal 454 to the IPDT_{B} using GR303 ABCD signaling. The ABCD-based ring signal is received at the IPDT_{B}, which converts the ring signal to a signal in the real time protocol stream (RTP) usually used for the voice channel.

In the payload of the RTP event packet 456, the event field may contain a named event such as ring, busy tone or other known telephony events. As an example, for a ring signal, the named event contained in the event field is represented by the decimal 89 which is associated with the ring event. The RTP event packet 456 is received at the destination gateway CG_{B}which parses the received packet, translates the RTP telephony event into an ABCD value 457 for ringing event and activates the ringer of a destination terminal (T_{B}) by applying an appropriate ringing voltage. As illustrated in FIG. 4, the LDS 210, while instructing the destination IPDT_{B} to ring the terminal T_{B}, sends a progress tone 458 to the terminal T_{A}. In the preferred embodiment, when the IPDT_{B} converts the ring control signal into the RTP stream, the caller ID information present in the DS0 is allowed to pass through the IPDT_{B} without demodulation. The caller ID information and the ring pattern are thus sent to the CG_{B} in their proper time sequence. The CG_{B} decodes the ring events in the RTP stream, controls the ringer, and plays out the caller ID signal in between the first and second rings. The caller ID information 460 may be displayed by the CG_{B} if provided with caller ID processing capability or it may be displayed by a caller ID display device.

When an off-hook event 462 is observed by the CG_{B}, it sends an RTP off-hook event packet 464 to the IPDT_{B} which translates the packet into an ABCD answer line signal 466. The IPDT_{B} forwards the signal to the LDS 210 which in return forwards it to the IPDT_{A}. The IPDT_{A} may then request the CG_{A} to be in a ‘send/receive’ mode in order to establish a full duplex voice connection 490.

FIG. 5A shows a flowchart for signaling an off-hook event to an IPDT_{A} using RTP. As illustrated in FIG. 5A, the off-hook event is detected by the CG_{A} at step 540 which processes the off hook event to generate an RTP telephone-event packet. At step 543, the CG_{A} creates an RTP telephone event packet. The RTP telephone event packet contains on its header portion a payload type identifying the packet as a named signal event packet which, in this instance, is an off-hook event. As previously stated herein, the RFC 2833 describes the method for transporting off-hook event over an RTP packet. At step 545, the RTP packet is sent to the IPDT_{A} for notification of the off-hook event.

FIG. 5B shows a flowchart for converting an RTP-based telephone event signaling into an ABCD signaling at a communication gateway which may be a destination gateway such as CG_{B}. At step 500, the CG_{B} receives an RTP stream and parses the stream to identify the RTP packets boundaries. The CG_{B} may then identify for each packet the header portion and the payload portion using, for example, pointers to buffers containing the two portions. At step 510, a pointer to the buffer containing the RTP header may be used to extract the payload type (PT) of the RTP packet. If the payload type is voice, a digital signal processor (DSP) present in the CG_{B} processes the voice information. If the payload type is a telephone event, the corresponding event is processed at step 520 which contains two sub-steps. At sub-step 522, the payload type is retrieved and at step 524 the telephone event type is determined and the corresponding ABCD value is passed to an Update_Rx_ABCD_Value step 530.

The operation of step 520 may be summarized by the following pseudo-code:

IF RTP Version is 2 or higher AND Extension flag is 0 AND

CSRC count is 0 AND Payload Type is Telephone-event

THEN

Pass ABCD value to update function

ELSE

Log an error

ENDIF.

Step 530 processes the ABCD value received from the process telephone-event step 520 and sends a message to the telephony hardware device driver (THDD), which in one embodiment is part of the CG_{B}420. The operation of step 530 in regard to the processing of ringing event may be summarized by the following pseudo-code:

IF the ABCD value is different from previous value

and the previous value is Ringer

THEN

Send message to THDD to undo the previous value

ENDIF.
IF the new ABCD value is Ringer

THEN

Send message to THDD to process the new value

ENDIF.

An advantage of the present system is that the IPDT 200 handles all of the call management sequences, thus eliminating the need for separate Call Agent hardware. The method and apparatus of the present invention may be employed in telecommunications systems using a GR303 -based interface or an ETSI V5-based interface to an access network.

This embodiment of the present invention maintains the timing relationship between the ABCD ring pattern and caller ID modulation by eliminating the delay time required for the IPDT_{B} to decode and parse the ring signal in order to detect special ring patterns. This results in a minimization of delay from the time a local digital switch requests ringing to the time the actual ringing occurs at the distant phone, while preserving appropriate timing for caller ID.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for interfacing a Public Switched Telephone Network (PSTN) with a Voice over IP (VoIP) enabled access network comprising the steps of:
(a) receiving incoming call signaling from a PSTN, wherein the incoming call signaling is in a digital trunk format;
(b) converting the call signaling to a packet-based VoIP call signaling message stream; and
(c) transmitting the packet based VoIP call signaling stream to a VoIP receiving device.

2. The method of claim 1, further comprising the steps of.
(d) receiving the packet-based VoIP call signaling at a VoIP receiving device; and
(e) generating signaling compatible with a residential PSTN phone device.

3. The method of claim 1, wherein the incoming call is in a GR-303 format.

4. The method of claim 1, wherein the incoming call signaling is in an ETSI V5 interface format.

5. A method for transporting ring control signals between a PSTN and a VoIP enabled access network so as to minimize delay and maintain caller ID timing, the method comprising the steps of:
(a) receiving robbed bit signaling from a PSTN, wherein the robbed bit signaling contains the ring control signals
(b) converting the robbed bit signaling to specialized packets in a VoIP signaling stream without parsing the robbed bit signaling to produce a high level ring command
(c) transmitting the specialized packets over a VoIP enabled access network.

6. The method of claim 5, further comprising the steps of:
(d) receiving the specialized packets at a VoIP enabled device; and
(e) converting the specialized packets to a series of PSTN end user device compatible signals.

7. The method of claim 5, wherein the timing relationship between the robbed bit signaling and the bearer channel traffic is sustained.

8. A system for interfacing a Public Switched Telephone Network (PSTN) with a Voice over IP (VoIP) enabled access network, comprising:
a local digital switch (LDS) application for a receiving incoming call signaling from a PSTN, wherein the incoming call signaling is in a digital trunk format;
a converter for converting the call signaling to a packet-based VoIP call signaling message stream; and
a VoIP application for transmitting the packet based VoIP call signaling stream to a VoIP receiving device.

9. The system of claim 8, whereby the VoIP application receives the packet-based VoIP call signaling and the LDS application generates signaling compatible with a residential PSTN phone device.

10. The system of claim 8, wherein the incoming call is in a GR-303 format.

11. The method of claim 8, wherein the incoming call signaling is in an ETSI V5 interface format.

12. The system of claim 8, whereby the converter further includes a signaling converter for processing control signals and a voice converter for processing voice signals.

13. A system for transporting ring control signals between a PSTN and a VoIP enabled access network so as to minimize delay and maintain caller ID timing, comprising:
a local digital switch (LDS) application for receiving robbed bit signaling from PSTN, wherein the robbed bit signaling contains the ring control signals;
a converter for converting the robbed bit signaling to specialized packets in a VoIP signaling stream without parsing the robbed bit signaling to produce a high level ring command; and
a VoIP application for transmitting the specialized packets over said VoIP enabled access network.

14. The system of claim 13, whereby the VoIP application receives the specialized packets and the converter converts the specialized packets to a series of PTSN end user device compatible signals.

15. The system of claim 13, whereby the converter further includes a signaling converter for processing control signals and a voice converter for processing voice signals.

16. An internet protocol digital terminal for interfacing a Public Switched telephone Network (PSTN) with a Voice over IP (VoIP) enabled network, comprising:
a first interface for receiving TDMA communications comprising voice and signaling information from said PSTN and providing the voice and signaling information to a converter; and
for receiving voice and signaling information from said converter and for transmitting TDMA communications to said PSTN;
a second interface for receiving VoIP communications comprising voice and signaling information from said VoIP enabled network and providing voice and signaling information to said converter; and
for receiving voice and signaling information from said converter and transmitting said voice and signaling information to said VoIP enabled network;
whereby said converter converts TDMA-based voice and signaling information to VoIP-based voice and signaling information and converts VoIP-based voice and signaling information to TDMA-based voice and signaling information.
